(19) United States
(12) Patent Application Publication
(10) Pub. No.: US 2020/0164624 A1
(43) Pub. Date: May 28, 2020

(54) FIBER-REINFORCED LAMINATES AND SANDWICH COMPOSITES INCLUDING THE SAME

(71) Applicant: Fibre Reinforced Thermoplastics B.V., Lelysted (NL)

(72) Inventors: Joris WISMANS, Lelystad (NL); Hendrik-Jan LEDEBOER, Lelystad (NL)

(21) Appl. No.: 16/638,348

(22) PCT Filed: Aug. 13, 2018
(86) PCT No.: PCT/IB2018/056096

§ 371 Date: Feb. 11, 2020

Related U.S. Application Data
(60) Provisional application No. 62/544,771, filed on Aug. 11, 2017.

(51) Int. Cl. B32B 27/06; B32B 7/12; B32B 5/18; B32B 27/32; B32B 3/12; B32B 27/18

(52) U.S. Cl. CPC B32B 27/065; B32B 7/12; B32B 5/18; B32B 27/32; B32B 3/12; B32B 27/18; B32B 2307/718; B32B 2260/023; B32B 2262/101; B32B 2262/106; B32B 2260/046; B32B 2250/40; B32B 2266/0264

(57) ABSTRACT

This disclosure includes fiber-reinforced laminates and sandwich composites comprising the same.

### CROSS-REFERENCE TO RELATED APPLICATION

This application claims priority to U.S. Provisional Patent App. No. 62/544,771 filed on Aug. 11, 2017, the entire content of which is incorporated herein by reference.

### BACKGROUND

### 1. Field of Invention

The present invention relates generally to fiber-reinforced composites, and, more specifically, to fiber-reinforced laminates and sandwich composites including the same.

### 2. Description of Related Art

Sandwich composites are composites that include a core layer and skin layers disposed on opposing sides of the core layer. In a typical sandwich composite, the core layer is thicker and less dense than the skin layers, and the skin layers are stiffer than the core layer. Through cooperation between its skin and core layers, a sandwich composite can have both a relatively high stiffness and a relatively low weight; for example, the stiff skin layers can resist bending of the composite, enhanced by positioning of the skin layers provided by the low-density core layer. Provided by way of illustration, a core layer can include foam, a honeycomb structure, aluminum, wood, and/or the like, and skin layers typically include fiber-reinforced laminates.

In many sandwich composites, the skin layers are cross-ply laminates, or laminates that include only 0 and 90° laminae. Driven by a desire to reduce weight and thickness, such cross-ply laminates are often asymmetric, such as those that include a single 0° lamina and a single 90° lamina.

Despite having a reduced weight and thickness, such a laminate—due to its asymmetric layup—may warp during consolidation and cooling. A warped laminate poses a number of challenges when producing a sandwich composite. For example, the warped laminate can frustrate its placement relative to a core layer, complicate its bonding to the core layer, damage equipment used for such bonding, induce warpage in the sandwich composite, and/or the like.

### SUMMARY

Some of the present laminates can resist warpage during consolidation and cooling (facilitating, inter alia, production of a sandwich composite using such laminates) by, for example, having: (1) an inner section comprising one or more unidirectional (UD) laminae, fibers of which are aligned in a first direction; and (2) first and second outer sections disposed on opposing sides of the inner section, each of the outer sections comprising one or more UD laminae, fibers of which are aligned in a second direction that is substantially perpendicular to the first direction.

Some such laminates can capture the above benefits without being undesirably thick and/or heavy by, for example, the UD lamina(e) of its inner section having a different collective thickness and/or areal weight than that of the UD lamina(e) of its first outer section and that of the UD lamina(e) of its second outer section. To illustrate, such a laminate in which, in each of the outer sections, the UD lamina(e) have a collective thickness and/or areal weight that is approximately half of the collective thickness and/or areal weight of the UD lamina(e) of its inner section can resist warpage during consolidation and cooling while having substantially the same thickness and/or areal weight as a conventional asymmetric laminate having same-thickness and/or same-areal weight 0 and 90° laminae.

At least by tailoring the collective thickness and/or areal weight of the UD lamina(e) of each of the outer and inner sections, some such laminates may not only resist warpage during consolidation and cooling and have thicknesses and/or areal weights comparable to that of conventional asymmetric, same-thickness and/or same-areal weight 0 and 90° laminae laminates, but may, at least when used in a sandwich composite, surprisingly provide for increased sandwich composite mechanical properties (e.g., maximum load, stiffnesses, ability to absorb energy) relative to when such conventional laminates are so used. Such laminates may include those in which the collective thickness and/or areal weight of the UD lamina(e) of the inner section is between 1.5 and 2.5 (e.g., between 1.5 and 2.0 times) that of the UD lamina(e) of the first outer section and that of the UD lamina(e) of the second outer section. It is believed that similar benefits may be obtained via a laminate having differing fiber weight and/or volume fractions for its inner and outer sections; for example, in such a laminate, for each of the outer sections, the fiber weight and/or volume fraction of the UD lamina(e) may be less than 95% (e.g., less than 90%) of the fiber weight and/or volume fraction of the UD lamina(e) of the inner section.

The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a top view of a first embodiment of the present laminates.

FIG. 2 depicts the layup of the laminate of FIG. 1.

FIG. 3 is a cross-sectional side view of the laminate of FIG. 1, taken along line 3-3 of FIG. 1.

FIG. 4 depicts the layup of a second embodiment of the present laminates.

FIG. 5 depicts an embodiment of the present sandwich composites.

FIGS. 6 and 7 depict presses suitable for producing embodiments of the present laminates and sandwich composites.

FIGS. 8A and 8B are images of embodiments of the present laminates.

FIG. 8C is an image of a comparative laminate.

FIGS. 9A-9C are images of comparative laminates.

FIGS. 10A-10H are images of embodiments of the present laminates.

FIG. 11 depicts a three-point bending test used to determine mechanical properties of embodiments of the present sandwich composites and comparative sandwich composites.

FIGS. 12A-12D are charts showing maximum loads, slopes, transverse shear stiffnesses, and flexural stiffnesses, respectively, for embodiments of the present sandwich composites and comparative sandwich composites.

FIG. 13 are graphs of load versus deflection during three-point bending tests of embodiments of the present sandwich composites and comparative sandwich composites.

FIG. 14 is a chart showing energy absorbed by embodiments of the present sandwich composites and comparative sandwich composites during three-point bending tests.

FIGS. 15A-15D are images of samples of embodiments of the present sandwich composites and comparative sandwich composites after three-point bending tests.

### DETAILED DESCRIPTION

The present laminates (e.g., 10a, 10b, and the like, described in more detail below) can include three or more UD laminae (e.g., any three or more of UD laminae 14a-14g), each including fibers (e.g., 18) dispersed within a polymeric matrix material (e.g., 22). The UD laminae can be layered such that the laminate includes: (1) an inner section (e.g., 26) having one or more of the UD laminae, the fibers of each of which are aligned in a first direction (e.g., 30); (2) a first outer section (e.g., 34a) having one or more of the UD laminae, the fibers of each of which are aligned in a second direction (e.g., 38) that is substantially perpendicular (i.e., within 10° of perpendicular) to the first direction; and (3) a second outer section (e.g., 34b) having one or more of the UD laminae, the fibers of each of which are aligned in the second direction, where the inner section is disposed between the first and second outer sections. Such a laminate can be characterized as a cross-ply laminate. In at least this way, some of the present laminates may resist warpage during consolidation and cooling.

In some laminates, one or more collective characteristics (e.g., a collective thickness, a collective areal weight, and the like) of the UD lamina(e) of the inner section differ from those of the UD lamina(e) of the first outer section and the UD lamina(e) of the second outer section. A collective characteristic of UD lamina(e) of a section is a characteristic of that section including contributions from each of its UD lamina(e), but excluding any contributions from non-UD lamina(e)—if present—of that section. To illustrate, for a section having a stack of three UD laminae and one non-UD lamina, the collective thickness of the UD laminae (which may be referred to as the thickness of the UD laminae of the section) is the sum of the thicknesses of the three UD laminae. And, the collective areal weight of the UD laminae (which may be referred to as the areal weight of the UD laminae of the section) is the sum of the areal weights of the three UD laminae.

In at least this way, some of the present laminates may have a weight and/or thickness comparable to (or a weight and/or thickness that are not undesirably increased relative to) conventional asymmetric laminates having same-thickness and/or same-areal weight 0 and 90° laminae. To illustrate, one of the present laminates in which, in each of the outer sections, the UD lamina(e) have a collective thickness and/or areal weight that is approximately half of the collective thickness and/or areal weight of the UD lamina(e) of its inner section can have substantially the same thickness and/or areal weight as a conventional asymmetric laminate having same-thickness and/or same-areal weight 0 and 90° laminae.

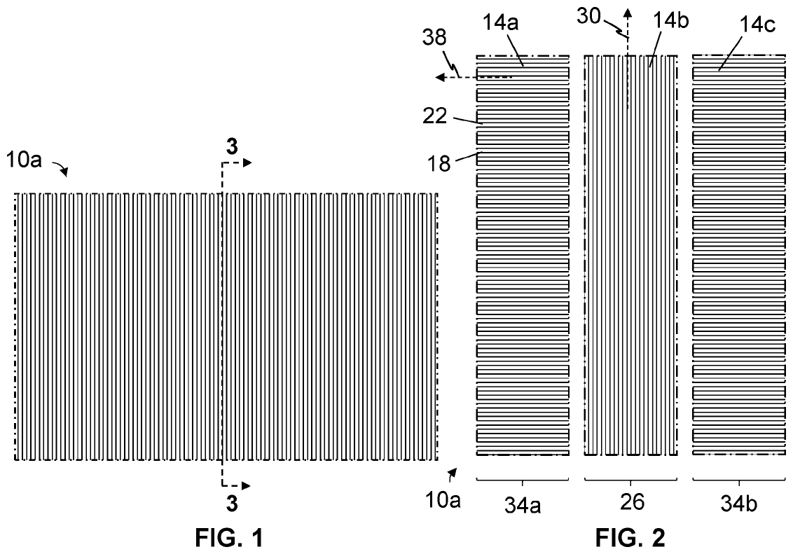

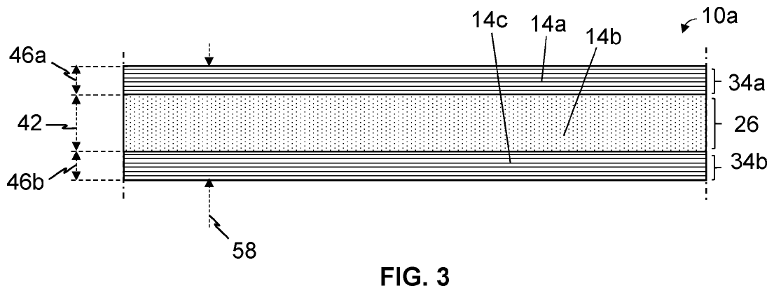

Referring now to FIGS. 1-3, shown is a first embodiment 10a of the present laminates. Laminate 10a can include three UD laminae 14a, 14b, and 14c. More particularly, each of inner section 26, first outer section 34a, and second outer section 34b can include a respective one of the UD laminae: the inner section can include UD lamina 14b, the first outer section can include UD lamina 14a, and the second outer section can include UD lamina 14c.

In laminate 10a, a collective thickness 46a of the UD lamina(e) in first outer section 34a (equal to a thickness of lamina 14a) can be substantially equal to a collective thickness 46b of the UD lamina(e) in second outer section 34b (equal to a thickness of lamina 14c). A collective thickness 42 of the UD lamina(e) in inner section 26 (equal to a thickness of lamina 14b) can be approximately 0.62 times thickness 46a and thickness 46b. To illustrate, thickness 42 can be approximately 0.156 millimeters (mm), and thicknesses 46a and 46b can each be approximately 0.250 mm. A collective thickness 58 of the UD laminae in laminate 10a—including contributions from each of UD laminae 14a-14c, and, if they were present, excluding contributions from any non-UD lamina(e)—can be approximately 0.66 mm; such a collective thickness may be referred to as the collective thickness of the UD laminae (without reference to a particular section). Thicknesses (e.g., 46a, 46b, and 58) referenced in this disclosure can be pre- or post-consolidation thicknesses.

A collective areal weight of the UD lamina(e) in first outer section 34a (equal to an areal weight of lamina 14a) can be substantially equal to a collective areal weight of the UD lamina(e) in second outer section 34b (equal to an areal weight of lamina 14c). A collective areal weight of the UD lamina(e) in inner section 26 (equal to an areal weight of lamina 14b) can be approximately 0.55 times the collective areal weight associated with the first outer section and the collective areal weight associated with the second outer section. To illustrate, the collective areal weight associated with the inner section can be approximately 237 grams per square meter (gsm), and the collective areal weights associated with first and second outer sections can each be approximately 428 gsm. A collective areal weight of the UD laminae in laminate 10a—including contributions from each of UD laminae 14a-14c, and, if they were present, excluding contributions from any non-UD lamina(e)—can be approximately 1093 gsm; such a collective areal weight may be referred to as the collective areal weight of the UD laminae (without reference to a particular section).

In laminate 10a, as with others of the present laminates, the UD lamina(e) of first outer section 34a can have substantially the same collective thickness and collective areal weight (described above), as well as the same fiber-type and matrix material (described below), as the UD lamina(e) of second outer section 34b. In this way, such laminates may be characterized as symmetric laminates.

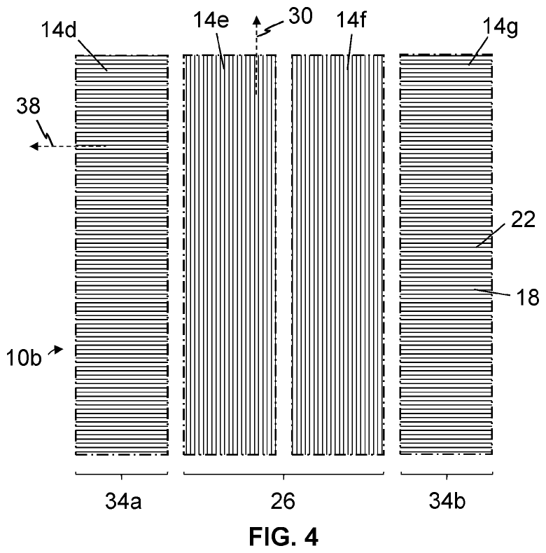

Referring now to FIG. 4, shown is the layup of a second embodiment 10b of the present laminates. Laminate 10b includes four UD laminae, 14d-14g. As shown, inner section 26 includes two of the UD laminae, 14e and 14f, and first outer section 34a and second outer section 34b each include a single one of the laminae, 14d and 14g, respectively.

In laminate 10b, a collective thickness (e.g., 46a) of the UD lamina(e) in first outer section 34a (equal to a thickness of lamina 14d) can be substantially equal to a collective thickness (e.g., 46b) of the UD lamina(e) in second outer section 34b (equal to a thickness of lamina 14g). A collective thickness (e.g., 42) of the UD lamina(e) in inner section 26 (equal to a thickness of lamina 14e plus a thickness of lamina 14f) can be approximately 1.25 times the collective thickness associated with first outer section 34a and the collective thickness associated with second outer section 34b. To illustrate, the collective thickness associated with the inner section can be approximately 0.312 mm, and the collective thicknesses associated with the first and second outer sections can each be approximately 0.250 mm. A collective thickness (e.g., 58) of the UD laminae in laminate 10b can be approximately 0.812 mm.

A collective areal weight of the UD lamina(e) in first outer section 34a (equal to an areal weight of lamina 14d) can be substantially equal to a collective areal weight of the UD lamina(e) in second outer section 34b (equal to an areal weight of lamina 14g). A collective areal weight of the UD lamina(e) in inner section 26 (equal to an areal weight of lamina 14e plus an areal weight of lamina 14f) can be approximately 1.11 times the collective areal weight associated with the first outer section and the collective areal weight associated with the second outer section. To illustrate, the collective areal weight associated with the inner section can be approximately 474 gsm, and the collective areal weights associated with the first and second outer sections can each be approximately 428 gsm. A collective areal weight of the UD laminae in laminate 10b can be approximately 1330 gsm.

TABLES 1-8 include the layups of laminates 10a and 10b as well as several other embodiments of the present laminates.

TABLE 1
Layup of Laminate 10a

| | | Fiber | | Areal |
|---|---|---|---|---|
| | | Orientation | Thickness | Weight |
| | Lamina | (°) | (mm) | (gsm) |
| First Outer Section | 1 | 90 | 0.250 | 428 |
| Inner Section | 2 | 0 | 0.156 | 237 |
| Second Outer Section | 3 | 90 | 0.250 | 428 |
| Totals: | | | 0.656 | 1093 |

TABLE 2
Layup of Laminate 10b

| | | Fiber | | Areal |
|---|---|---|---|---|
| | | Orientation | Thickness | Weight |
| | Lamina | (°) | (mm) | (gsm) |
| First Outer Section | 1 | 90 | 0.250 | 428 |
| Inner Section | 2 | 0 | 0.156 | 237 |
| | 3 | 0 | 0.156 | 237 |
| Second Outer | 4 | 90 | 0.250 | 428 |
| Section | | | | |
| Totals: | | | 0.812 | 1330 |

TABLE 3
Layup of Exemplary Laminate

| | | Fiber | | Areal |
|---|---|---|---|---|
| | | Orientation | Thickness | Weight |
| | Lamina | (°) | (mm) | (gsm) |
| First Outer Section | 1 | 90 | 0.156 | 237 |
| Inner Section | 2 | 0 | 0.250 | 428 |
| Second Outer | 3 | 90 | 0.156 | 237 |
| Section | | | | |
| Totals: | | | 0.562 | 902 |

TABLE 4
Layup of Exemplary Laminate

| | | Fiber | | Areal |
|---|---|---|---|---|
| | | Orientation | Thickness | Weight |
| | Lamina | (°) | (mm) | (gsm) |
| First Outer Section | 1 | 90 | 0.156 | 237 |
| Inner Section | 2 | 0 | 0.156 | 237 |
| Second Outer | 3 | 90 | 0.156 | 237 |
| Section | | | | |
| Totals: | | | 0.468 | 711 |

TABLE 5
Layup of Exemplary Laminate

| | | Fiber | | Areal |
|---|---|---|---|---|
| | | Orientation | Thickness | Weight |
| | Lamina | (°) | (mm) | (gsm) |
| First Outer Section | 1 | 90 | 0.156 | 237 |
| Inner Section | 2 | 0 | 0.250 | 428 |
| | 3 | 0 | 0.250 | 428 |
| Second Outer | 4 | 90 | 0.156 | 237 |
| Section | | | | |
| Totals: | | | 0.812 | 1330 |

TABLE 6
Layup of Exemplary Laminate

| | | Fiber | | Areal |
|---|---|---|---|---|
| | | Orientation | Thickness | Weight |
| | Lamina | (°) | (mm) | (gsm) |
| First Outer Section | 1 | 90 | 0.156 | 237 |
| Inner Section | 2 | 0 | 0.156 | 237 |
| | 3 | 0 | 0.156 | 237 |
| Second Outer | 4 | 90 | 0.156 | 237 |
| Section | | | | |
| Totals: | | | 0.624 | 948 |

TABLE 7
Layup of Exemplary Laminate

| | | Fiber | | Areal |
|---|---|---|---|---|
| | | Orientation | Thickness | Weight |
| | Lamina | (°) | (mm) | (gsm) |
| First Outer Section | 1 | 90 | 0.250 | 428 |
| Inner Section | 2 | 0 | 0.250 | 428 |
| | 3 | 0 | 0.250 | 428 |
| Second Outer | 4 | 90 | 0.250 | 428 |
| Section | | | | |
| Totals: | | | 1.000 | 1712 |

TABLE 8
Layup of Exemplary Laminate

| | | Fiber | | Areal |
|---|---|---|---|---|
| | | Orientation | Thickness | Weight |
| | Lamina | (°) | (mm) | (gsm) |
| First Outer Section | 1 | 90 | 0.250 | 428 |
| Inner Section | 2 | 0 | 0.250 | 428 |
| Second Outer | 3 | 90 | 0.250 | 428 |
| Section | | | | |
| Totals: | | | 0.750 | 1284 |

Other embodiments of the present laminates can include any suitable number of UD laminae (e.g., 3, 4, 5, 6, 7, 8, 9, 10, or more UD laminae), which can be distributed amongst each of an inner section (e.g., 26), a first outer section (e.g., 34a), and a second outer section (e.g., 34b) of the laminate in any suitable fashion.

The UD lamina(e) of each of the inner section, the first outer section, and the second outer section can have any suitable collective thickness. To illustrate, the collective thickness of the UD lamina(e) of the inner section (e.g., 42), the collective thickness of the UD lamina(e) of the first outer section (e.g., 46a), and the collective thickness of the UD lamina(e) of the second outer section (e.g., 46b) can each be greater than or substantially equal to any one of, or between any two of: 0.10, 0.12, 0.14, 0.16, 0.18, 0.20, 0.22, 0.24, 0.26, 0.28, 0.30, 0.32, 0.34, 0.36, 0.38, 0.40, 0.42, 0.44, 0.46, 0.48, 0.50, 0.52, 0.54, 0.56, 0.58, or 0.60 mm. To further illustrate, the collective thickness associated with the inner section can be greater than or substantially equal to any one of, or between any two of: 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, or 3.5 times (e.g., from 0.6 to 3.25 times) the collective thickness associated with the first outer section and the collective thickness associated with the second outer section. The collective thickness of the UD laminae in the laminate can be greater than or substantially equal to any one of, or between any two of: 0.20, 0.25, 0.30, 0.35, 0.40, 0.45, 0.50, 0.55, 0.60, 0.65, 0.70, 0.75, 0.80, 0.85, 0.90, 0.95, 1.00, 1.05, 1.10, 1.15, 1.20, 1.25, 1.30, 1.35, 1.40, 1.45, or 1.50 mm (e.g., between approximately 0.40 mm and approximately 1.0 mm).

The UD lamina(e) of each of the inner section, the first outer section, and the second outer section can have any suitable collective areal weight. To illustrate, the collective areal weight of the UD lamina(e) in the inner section, the collective areal weight of the UD lamina(e) in the first outer section, and the collective areal weight of the UD lamina(e) in the second outer section can each be greater than or substantially equal to any one of, or between any two of: 200, 225, 250, 275, 300, 325, 350, 375, 400, 425, 450, 475, 500, 525, 550, 575, 600, 625, 650, 675, 700, 725, 750, 775, 800, 825, 850, 875, 900, or 925 gsm. To further illustrate, the collective areal weight associated with the inner section can be greater than or substantially equal to any one of, or between any two of: 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, or 4.0 times (e.g., from 0.5 to 3.7 times) the collective areal weight associated with the first outer section and the collective areal weight associated with the second outer section. The collective areal weight of the UD laminae in the laminate can be greater than or substantially equal to any one of, or between any two of: 600, 625, 650, 675, 700, 725, 750, 775, 800, 825, 850, 875, 900, 925, 950, 975, 1000, 1025, 1050, 1075, 1100, 1125, 1150, 1175, 1200, 1225, 1250, 1275, 1300, 1325, 1350, 1375, 1400, 1425, 1450, 1475, 1500, 1525, 1550, 1575, 1600, 1625, 1650, 1675, 1700, 1725, 1750, 1775, or 1800 gsm.

At least by tailoring the collective thickness and/or areal weight of the UD lamina(e) of each of the outer and inner sections, some of the present laminates may not only resist warpage during consolidation and cooling and, in some instances, have thicknesses and/or areal weights comparable to that of conventional asymmetric, same-thickness and/or same-areal weight 0 and 90° laminae laminates, but may, at least when used in a sandwich composite, surprisingly provide for increased sandwich composite mechanical properties (e.g., maximum load, stiffnesses, ability to absorb energy) relative to when such conventional laminates are so used. Such laminates may include those in which: (1) the collective thickness of the UD lamina(e) of the inner section is between 1.5 and 2.5 times (e.g., between 1.5 and 2.0 times or approximately 1.6 times) that of the UD lamina(e) of the first outer section and that of the UD lamina(e) of the second outer section; and/or (2) the collective areal weight of the UD lamina(e) of the inner section is between 1.5 and 2.5 times (e.g., between 1.5 and 2.0 times or approximately 1.8 times) that of the UD lamina(e) of the first outer section and that of the UD lamina(e) of the second outer section.

It is believed that such increased sandwich composite mechanical properties may also be obtained via a laminate having differing fiber weight and/or volume fractions for its inner and outer sections. In such a laminate, for example, the fiber weight and/or volume fraction of the UD laminae of the first and second outer sections can be less than 95% (e.g., less than 90%, less than 85%, or between 80 and 95%) of the fiber weight and/or volume fraction of the UD lamina(e) of the inner section.

UD laminae (e.g., 14a-14g) of the present laminates (e.g., 10a, 10b, and the like) can be formed from UD tape. For example, a UD lamina can be formed from a single section of UD tape or from multiple sections of UD tape that are placed adjacent to one another. Non-limiting examples of such UD tapes, as well as systems and methods for making such UD tapes, can be found in: (1) Pub. No. WO 2016142784 A1; and (2) International Patent App. No. PCT/IB2018/051673, filed Mar. 13, 2018 and entitled “UNIDIRECTIONAL FIBER TAPES AND METHODS AND SYSTEMS FOR PRODUCING THE SAME,” each of which is hereby incorporated by reference in its entirety.

UD laminae (e.g., 14a-14g) of the present laminates (e.g., 10a, 10b, and the like) can comprise any suitable fibers (e.g., 18), such as, for example, carbon fibers, glass fibers, aramid fibers, polyethylene fibers, polyester fibers, polyamide fibers, ceramic fibers, basalt fibers, and/or steel fibers (e.g., carbon fibers and/or glass fibers). Within a given laminate, the UD laminae can, but need not, comprise the same type of fibers; for example, in some laminates, one or more of the UD laminae (e.g., of each of the outer sections) can comprise glass fibers, and one or more of the UD laminae (e.g., of the inner section) can comprise carbon fibers.

A polymeric matrix material (e.g., 22) of a UD lamina (e.g., any of 14a-14g) can include a thermoplastic material, such as, for example, polyethylene terephthalate (PET), polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polystyrene sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof.

A polymeric matrix material (e.g., 22) of a UD lamina (e.g., any of 14a-14g) can include a flame retardant, such as, for example, a phosphate structure (e.g., resorcinol bis(diphenyl phosphate)), a sulfonated salt, halogen, phosphorous, talc, silica, a hydrated oxide, a brominated polymer, a chlorinated polymer, a phosphorated polymer, a nanoclay, an organoclay, a polyphosphonate, a poly[phosphonate-co-carbonate], a polytetrafluoroethylene and styrene-acrylonitrile copolymer, a polytetrafluoroethylene and methyl methacrylate copolymer, a polysilixane copolymer, and/or the like.

A polymeric matrix material (e.g., 22) of a UD lamina (e.g., any of 14a-14g) can include one or more additives, such as, for example, a coupling agent to promote adhesion between the polymeric matrix material and fibers (e.g., 18) of the lamina, an antioxidant, a heat stabilizer, a flow modifier, a stabilizer, a UV stabilizer, a UV absorber, an impact modifier, a cross-linking agent, a colorant, or a combination thereof. Non-limiting examples of a coupling agent include POLYBOND 3150 maleic anhydride grafted polypropylene, commercially available from DUPONT, FUSABOND P613 maleic anhydride grafted polypropylene, commercially available from DUPONT, maleic anhydride ethylene, or a combination thereof. A non-limiting example of a flow modifier is CR20P peroxide masterbatch, commercially available from POLYVEL INC. A non-limiting example of a heat stabilizer is IRGANOX B 225, commercially available from BASF. Non-limiting examples of UV stabilizers include hindered amine light stabilizers, hydroxybenzophenones, hydroxyphenyl benzotriazoles, cyanoacrylates, oxanilides, hydroxyphenyl triazines, and combinations thereof. Non-limiting examples of UV absorbers include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, or combinations thereof. Non-limiting examples of impact modifiers include Non-limiting examples of impact modifiers include elastomers/soft blocks dissolved in one or more matrix-forming monomers (e.g., bulk HIPS, bulk ABS, reactor modified PP, LOMOD, LEXAN EXL, and/or the like), thermoplastic elastomers dispersed in a matrix material by compounding (e.g., di-, tri-, and multiblock copolymers, (functionalized) olefin (co)polymers, and/or the like), pre-defined core-shell (substrate-graft) particles distributed in a matrix material by compounding (e.g., MBS, ABS-HRG, AA, ASA-XTW, SWIM, and/or the like), or combinations thereof. Non-limiting examples of cross-linking agents include divinylbenzene, benzoyl peroxide, alkylenediol di(meth)acrylates (e.g., glycol bisacrylate and/or the like), alkylenetriol tri(meth)acrylates, polyester di(meth)acrylates, bisacrylamides, triallyl cyanurate, triallyl isocyanurate, allyl (meth)acrylate, diallyl maleate, diallyl fumarate, diallyl adipate, triallyl esters of citric acid, triallyl esters of phosphoric acid, or combinations thereof. Such one or more additives can include neat polypropylene.

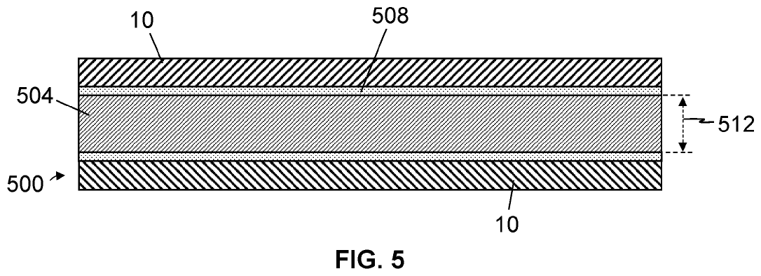

Referring now to FIG. 5, shown is one embodiment 500 of the present sandwich composites. Sandwich composite 500 can include a core 504, which, in turn, can include one or more core layers. As shown, sandwich composite 500 includes two of the present laminates 10 (e.g., two of any of the laminates described above) bonded to opposing sides of core 504. Such bonding can be accomplished via, for example, application of heat and pressure, adhesive (e.g., adhesive films 508), and/or the like. A thickness 512 of core 504 can be greater than or substantially equal to any one of, or between any two of: 15, 20, 25, 30, 35, 40, 45, 50, 55, 60, or 65 times (e.g., between 20 and 60 times, between 35 and 50 times, or approximately 40 times) the thickness (e.g., 58) of the UD laminae of the laminate on one of its sides and the thickness (e.g., 58) of the UD laminae of the laminate on the other of its sides.

Core 504—or any of its layer(s)—can comprise any suitable material, such as, for example, foam (e.g., open cell, closed cell, and/or the like), a honeycomb structure (e.g., which can comprise and/or be filled with foam), wood, a thermoplastic material (e.g., any of the thermoplastic materials described above), and/or the like. Sandwich composite 500 can include one or more layers in addition to core 504 and laminates 10, such as foil layer(s), mesh layer(s), and/or the like.

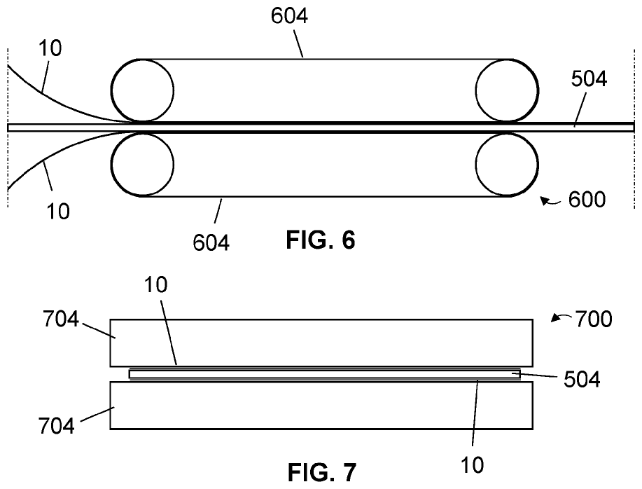

Some embodiments of the present methods comprise forming each of one or more laminates (e.g., one or more of any laminate described above) by stacking three or more UD laminae according to the layup of the laminate and applying heat and pressure to the stack to consolidate the stack. Such heat and pressure can be applied by pressing the stack between belts of a double belt press (e.g., belts 604 of double belt press 600, FIG. 6), between platens of a static press (e.g., platens 704 of static press 700, FIG. 7), or the like. Some methods comprise bonding two such laminates to opposing sides of a core (e.g., 504) to form a sandwich composite (e.g., 500). Such bonding can be performed using a double belt press (e.g., 600); for example, the laminates can be unwound from respective rolls and fed between belts (e.g., 604) of the double belted press with the core disposed between the laminates. Such bonding can be performed using a static press (e.g., 700) in which the core is disposed between the laminates and the core and the laminates are pressed between platens (e.g., 704) of the press.

Some of the present laminates comprise: three or more UD laminae, each having a polymeric matrix material and fibers dispersed within the polymeric matrix material, wherein the UD laminae are layered such that the laminate includes: (1) an inner section having one or more of the UD laminae, in each of which the fibers are aligned in a first direction, and that collectively have a thickness; and (2) first and second outer sections disposed on opposing sides of the inner section, each including one or more of the UD laminae, in each of which the fibers are aligned in a second direction that is substantially perpendicular to the first direction, and that collectively have a thickness, wherein the thickness of the first outer section is substantially equal to the thickness of the second outer section, and wherein the thickness of the inner section is 0.6 to 3.24 times the thickness of the first outer section and the thickness of the second outer section, and wherein a collective thickness of the UD laminae is between approximately 0.5 mm and approximately 1.0 mm.

In some laminates, the thickness of the inner section is approximately 0.16 mm, and the thickness of the first outer section and the thickness of the second outer section are each approximately 0.25 mm. In some laminates, the thickness of the inner section is approximately 0.25 mm, and the thickness of the first outer section and the thickness of the second outer section are each approximately 0.16 mm. In some laminates, the thickness of the inner section is approximately 0.32 mm, and the thickness of the first outer section and the thickness of the second outer section are each approximately 0.25 mm. In some laminates, the thickness of the inner section is approximately 0.50 mm, and the thickness of the first outer section and the thickness of the second outer section are each approximately 0.16 mm.

In some laminates, a collective areal weight of the UD lamina(e) of the inner section is 0.5 to 3.6 times a collective areal weight of the UD lamina(e) of the first outer section and a collective areal weight of the UD lamina(e) of the second outer section. In some laminates, a collective areal weight of the UD laminae is between approximately 850 gsm and approximately 1300 gsm.

In some laminates, the fibers comprise carbon fibers, glass fibers, aramid fibers, polyethylene fibers, polyester fibers, polyamide fibers, ceramic fibers, basalt fibers, and/or steel fibers. In some laminates, the fibers comprise carbon fibers and/or glass fibers.

In some laminates, the polymeric matrix material comprises a thermoplastic matrix material, and, optionally, the thermoplastic matrix material comprises PET, PC, PBT, PCCD, PCTG, PPO, PP, PE, PVC, PS, PMMA, PEI or a derivative thereof, a TPE, a TPA elastomer, PCT, PEN, a PA, PSS, PEEK, PEKK, ABS, PPS, a copolymer thereof, or a blend thereof. In some laminates, the thermoplastic matrix material comprises PP.

Some of the present sandwich composites comprise a core including one or more core layers, and two of the present laminates disposed on opposing sides of the core. In some sandwich composites, at least one of the core layer(s) comprises foam and/or a honeycomb structure.

Some of the present methods comprise: forming each of one or more laminates at least by stacking three or more UD laminae, each including fibers dispersed within a polymeric matrix material, to form a stack that includes: (1) an inner section having one or more of the UD laminae, in each of which the fibers are aligned in a first direction, and that collectively have an areal weight; and (2) first and second outer sections disposed on opposing sides of the inner section, each including one or more of the UD laminae, in each of which the fibers are aligned in a second direction that is substantially perpendicular to the first direction, and that collectively have an areal weight, wherein the areal weight of the first outer section is substantially equal to the areal weight of the second outer section, wherein the areal weight of the inner section is 0.5 to 3.6 times the areal weight of the first outer section and the areal weight of the second outer section, and wherein a collective areal weight of the UD laminae is between approximately 850 gsm and approximately 1300 gsm, and applying heat and pressure to the stack to consolidate the stack.

In some methods, for the stack of at least one of the laminate(s), the areal weight of the inner section is approximately 228 gsm, and the areal weight of the first outer section and the areal weight of the second outer section are each approximately 410 gsm. In some methods, for the stack of at least one of the laminate(s), the areal weight of the inner section is approximately 410 gsm, and the areal weight of the first outer section and the areal weight of the second outer section are each approximately 228 gsm. In some methods, for the stack of at least one of the laminate(s), the areal weight of the inner section is approximately 456 gsm, and the areal weight of the first outer section and the areal weight of the second outer section are each approximately 410 gsm. In some methods, for the stack of at least one of the laminate(s), the areal weight of the inner section is approximately 810 gsm, and the areal weight of the first outer section and the areal weight of the second outer section are each approximately 228 gsm. In some methods, for the stack of at least one of the laminate(s), the areal weight of the inner section is approximately 456 gsm, and the areal weight of the first outer section and the areal weight of the second outer section are each approximately 228 gsm.

In some methods, for the stack of at least one of the laminate(s), a collective thickness of the UD lamina(e) of the inner section is 0.6 to 3.25 times a collective thickness of the UD lamina(e) of the first outer section and a collective thickness of the UD lamina(e) of the second outer section. In some methods, for the stack of at least one of the laminate(s), a collective thickness of the UD laminae is between approximately 0.50 mm and approximately 1.0 mm.

In some methods, for the stack of at least one of the laminate(s), the fibers comprise carbon fibers, glass fibers, aramid fibers, polyethylene fibers, polyester fibers, polyamide fibers, ceramic fibers, basalt fibers, and/or steel fibers. In some methods, the fibers comprise carbon fibers and/or glass fibers.

In some methods, for the stack of at least one of the laminate(s), the polymeric matrix material comprises a thermoplastic matrix material, and, optionally, the thermoplastic matrix material comprises PET, PC, PBT, PCCD, PCTG, PPO, PP, PE, PVC, PS, PMMA, PEI or a derivative thereof, a TPE, a TPA elastomer, PCT, PEN, a PA, PSS, PEEK, PEKK, ABS, PPS, a copolymer thereof, or a blend thereof. In some methods, the thermoplastic matrix material comprises PP.

In some methods, the laminate(s) include first and second laminates, and the method comprises bonding the first and second laminates to opposing sides of a core. In some methods, the core includes foam and/or a honeycomb structure. In some methods, bonding the first and second laminates to opposing sides of the core is performed using a double belt press or a static press.

### EXAMPLES

The present invention will be described in greater detail by way of specific examples. The following examples are offered for illustrative purposes only and are not intended to limit the invention in any manner. Those of skill in the art will readily recognize a variety of non-critical parameters that can be changed or modified to yield essentially the same results.

### Example 1

### Sample and Comparative Laminates

### A. Warpage of Sample and Comparative Laminates I

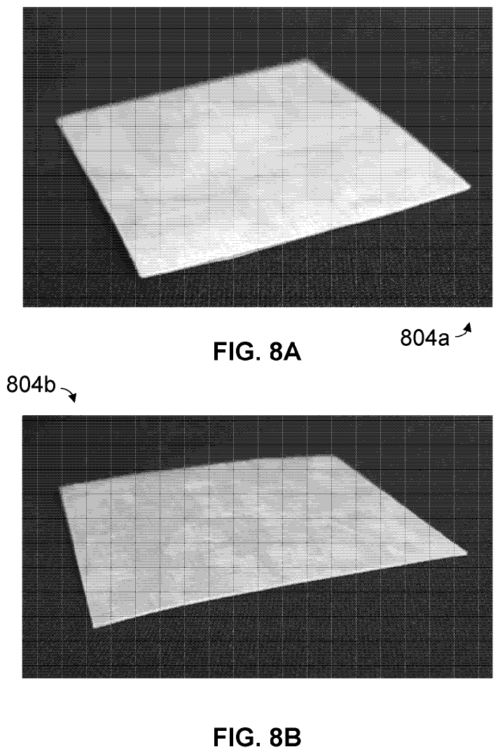

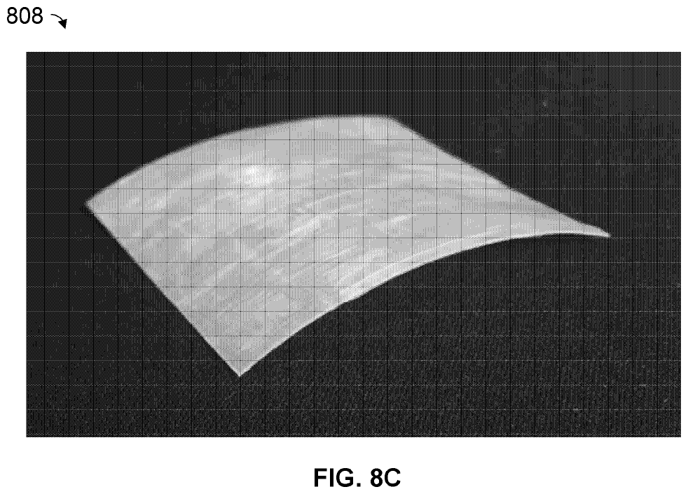

FIGS. 8A and 8B are images of embodiments of the present laminates (such laminates are sometimes referred to as “sample laminates”), 804a and 804b, respectively. The laminae of these laminates each included glass fibers and polypropylene matrix material. Laminates 804a and 804b were symmetric, having the layups provided in TABLE 9, below.

TABLE 9
Layups for Laminates 804a and 804b

| | Laminate 804a | | | | Laminate 804b | | | |
|---|---|---|---|---|---|---|---|---|
| Laminae | | | | Fiber | | | | Fiber |
| (ordered | Fiber | | Areal | Weight | Fiber | | Areal | Weight |
| from top | Orientation | Thickness | Weight | Fraction | Orientation | Thickness | Weight | Fraction |
| to bottom) | (°) | (mm) | (gsm) | (%) | (°) | (mm) | (gsm) | (%) |
| 1 | 90 | 0.156 | 237 | 61.71 | 90 | 0.156 | 237 | 61.71 |
| 2 | 0 | 0.156 | 237 | 61.71 | 0 | 0.156 | 237 | 61.71 |
| 3 | 90 | 0.156 | 237 | 61.71 | 0 | 0.156 | 237 | 61.71 |
| 4 | — | — | — | | 90 | 0.156 | 237 | 61.71 |

*All properties were measured.

Due to symmetry of their layups, laminates 804a and 804b exhibited minimal warpage during consolidation and cooling (FIGS. 8A and 8B).

A comparative laminate 808 was prepared that had an asymmetric layup consisting of a single 0° lamina and a single 90° lamina. As with laminates 804a and 804b, the laminae of laminate 808 each had glass fibers and polypropylene matrix material. As shown in FIG. 8C, laminate 808 suffered from significant warpage—at least when compared to laminates 804a and 804b—during consolidation and cooling.

### B. Warpage of Sample and Comparative Laminates II

Sample and comparative laminates were each prepared by cutting laminae from one or more rolls of UD tape, stacking the laminae, and consolidating the stack using a double belt press. To mitigate lamina misalignment during stack infeed to the double belt press, in each stack, the laminae were first spot welded to one another along the stack's leading edge (the edge at which the stack was introduced to the double belt press). The double belt press was operated using the parameters set forth in TABLE 10.

TABLE 10
Double Belt Press Operating Parameters

| Parameter | Value | |
|---|---|---|
| Machine Speed | 3.0 | m/min |
| Temperature of Heating Zone | 185.0° | C. |
| Temperature of Cooling Zone | 25.0° | C. |
| Gap at Heating Zone | 0.3 | mm |
| Gap at Nip Roller | 0.2 | mm |
| Gap at Cooling Zone | 0.2 | mm |
| Length of Heating Zone | 4.5 | m |
| Length of Cooling Zone | 3.5 | m |

The UD tapes used to produce the laminates each included glass fibers and polypropylene matrix material having the respective properties in TABLE 11.

TABLE 11
Properties of UD Tape Fibers and Matrix Material*

| | | Modulus of | Tensile |
|---|---|---|---|
| | Density | Elasticity | Strength |
| Material | (kg/m³) | (GPa) | (MPa) |
| Glass Fibers | 2620 | 77 | 2250 |
| Polypropylene | 910 | 1.45 | 35 |
| Matrix | | | |
| Material | | | |

*Values from suppliers' data sheets.

The UD tapes were each of one of two types, the two types having differing thicknesses and fiber fractions. Properties of these UD tape types are included in TABLE 12.

TABLE 12
UD Tape Properties*

| | UD Tape 1 | UD Tape 2 |
|---|---|---|
| Thickness (mm) | 0.156 | 0.250 |
| Fiber Weight | 61.71 | 71.69 |
| Fraction (%) | | |
| Fiber Volume | 35.89 | 46.80 |
| Fraction (%) | | |
| Density (kg/m³) | 1524 | 1710 |
| Areal Weight | 0.237 | 0.428 |
| (kg/m²) | | |
| Elastic Modulus | 28.56 | 36.81 |
| in 0° Direction | | |
| Elastic Modulus | 2.24 | 2.68 |
| in 90° Direction | | |
| Tensile Strength | 830 | 1072 |
| (MPa) | | |

*Thicknesses and fiber weight fractions were measured, all other properties were calculated as set forth in AUTAR K. KAW, MECHANICS OF COMPOSITE MATERIALS (2nd ed. 2006).

The UD tape type of a UD tape or lamina discussed below can be identified using its thickness: 0.156 mm thick UD tapes or laminae are of UD Tape 1, and 0.250 mm thick UD tapes or laminae are of UD Tape 2.

The laminates included comparative, asymmetric laminates, each being one of types C1-C3, and sample, symmetric laminates, each being one types S1-S8; for each type, several laminates were produced. Properties of these laminate types are included in TABLE 13, below.

TABLE 13
Sample and Comparative Laminate Properties

| | | Fiber | | Areal |
|---|---|---|---|---|
| | | Orientation | Thickness | Weight |
| Laminate | Layup | (°) | (mm) | (gsm) |
| C1 | Lamina 1 | 0 | 0.250 | 428 |
| | Lamina 2 | 90 | 0.250 | 428 |
| | Totals: | | 0.500 | 856 |
| C2 | Lamina 1 | 0 | 0.156 | 237 |
| | Lamina 2 | 90 | 0.156 | 237 |
| | Totals: | | 0.312 | 474 |
| C3 | Lamina 1 | 0 | 0.156 | 237 |
| | Lamina 2 | 90 | 0.250 | 428 |
| | Totals: | | 0.406 | 665 |
| S1 | Lamina 1 | 90 | 0.250 | 428 |
| | Lamina 2 | 0 | 0.250 | 428 |
| | Lamina 3 | 90 | 0.250 | 428 |
| | Totals: | | 0.750 | 1284 |
| S2 | Lamina 1 | 90 | 0.156 | 237 |
| | Lamina 2 | 0 | 0.156 | 237 |
| | Lamina 3 | 90 | 0.156 | 237 |
| | Totals: | | 0.468 | 711 |
| S3 | Lamina 1 | 90 | 0.156 | 237 |
| | Lamina 2 | 0 | 0.250 | 428 |
| | Lamina 3 | 90 | 0.156 | 237 |
| | Totals: | | 0.562 | 902 |
| S4 | Lamina 1 | 90 | 0.250 | 428 |
| | Lamina 2 | 0 | 0.156 | 237 |
| | Lamina 3 | 90 | 0.250 | 428 |
| | Totals: | | 0.656 | 1093 |
| S5 | Lamina 1 | 90 | 0.250 | 428 |
| | Lamina 2 | 0 | 0.250 | 428 |
| | Lamina 3 | 0 | 0.250 | 428 |
| | Lamina 4 | 90 | 0.250 | 428 |
| | Totals: | | 1.000 | 1712 |
| S6 | Lamina 1 | 90 | 0.156 | 237 |
| | Lamina 2 | 0 | 0.156 | 237 |
| | Lamina 3 | 0 | 0.156 | 237 |
| | Lamina 4 | 90 | 0.156 | 237 |
| | Totals: | | 0.624 | 948 |
| S7 | Lamina 1 | 90 | 0.250 | 428 |
| | Lamina 2 | 0 | 0.156 | 237 |
| | Lamina 3 | 0 | 0.156 | 237 |
| | Lamina 4 | 90 | 0.250 | 428 |
| | Totals: | | 0.812 | 1330 |
| S8 | Lamina 1 | 90 | 0.156 | 237 |
| | Lamina 2 | 0 | 0.250 | 428 |
| | Lamina 3 | 0 | 0.250 | 428 |
| | Lamina 4 | 90 | 0.156 | 237 |
| | Totals: | | 0.812 | 1330 |

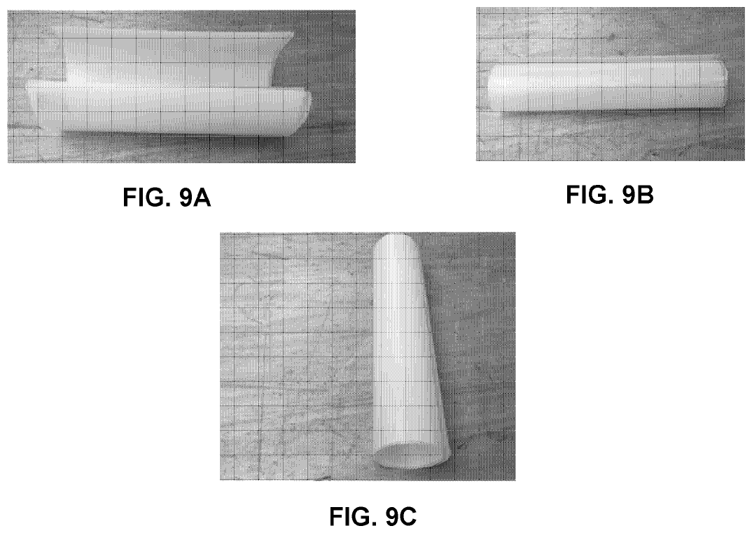

FIG. 9A-9C depict one of the C1 laminates (FIG. 9A), one of the C2 laminates (FIG. 9B), and one of the C3 laminates (FIG. 9B). In each of these figures, fibers of the 0° lamina run from left to right. As shown, the comparative laminates suffered from significant warpage. The magnitude and direction of such warpage was layup dependent. To illustrate, the C1 laminate with thicker laminae warped less than the C2 laminate with thinner laminae. To further illustrate, the C1 and C2 laminates, each having equal thickness 0° and 90° laminae, curled primary about the 0° direction, while the C3 laminae, whose 90° lamina was thicker than its 00 lamina, curled primarily about the 90° direction.

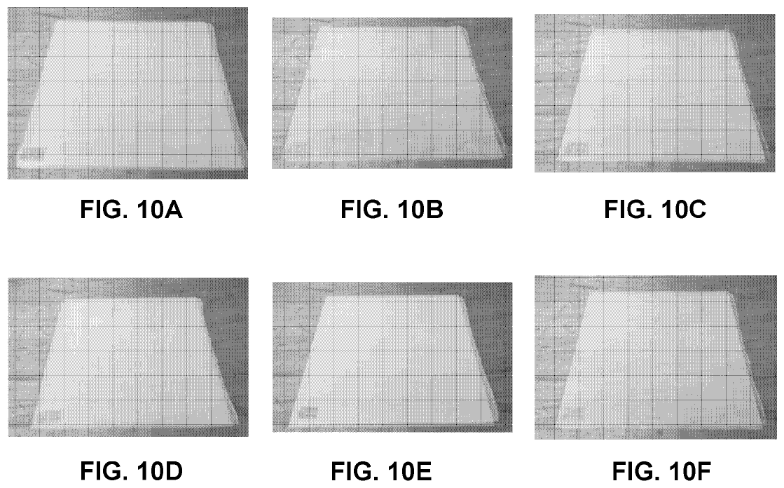

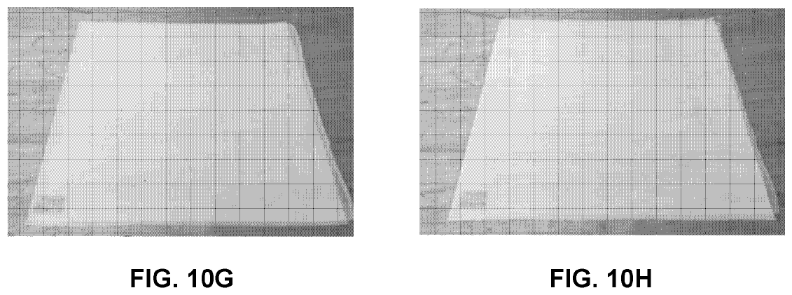

FIGS. 10A-10H depict one of the S1 laminates (FIG. 10A), one of the S2 laminates (FIG. 10B), one of the S3 laminates (FIG. 10C), one of the S4 laminates (FIG. 10D), one of the S5 laminates (FIG. 10E), one of the S6 laminates (FIG. 10F), one of the S7 laminates (FIG. 10G), and one of the S8 laminates (FIG. 10H). As with FIGS. 9A-9C, in each of FIGS. 10A-10H, fibers of the 0° lamina(e) run from left to right. Notwithstanding the range of layups covered by the S1-S8 laminates, they—at least in part because those layups are symmetrical—exhibited minimal warpage.

### Example 2

### Sample and Comparative Sandwich Composites

### A. Production of Sample and Comparative Sandwich Composites

Sample and comparative sandwich composites were each produced by disposing two of the sample or comparative laminates on opposing sides of a foam core with an adhesive film placed between each of the laminates and the core. For each of the sandwich composites, the foam core comprised ARMACEL structural PET-W (welded) and had a thickness of 24 mm, a density of 70 kg/m³, and a shear modulus of 13 MPa, and the adhesive films each comprised FAITERM A77-100 and had a thickness of 100 m and a density of 960 kg/m³.

The sandwich composites were each consolidated with a static press using the same procedure, which was selected based on several tests to ensure a good bond between sandwich composite components. The pressing procedure was as follows:
1. The press was preheated to 150° C.
2. The non-consolidated sandwich composite layup was disposed within a steel mold, which, in turn, was disposed within the press.
3. A pressure of 4 bar was applied by the press to the sandwich composite (via the mold).
4. With the pressure still applied, the mold was cooled by 15° C. per minute for 520 seconds (this reduced heat penetration into the core without undesirably hindering adhesive film activation).
5. The pressure was removed, the mold was taken out of the press, and the consolidated sandwich composite was retrieved from the mold and subsequently allowed to cool to room temperature.

Two sets of comparative sandwich composites were produced: (1) a PC1 set, each of which had C1 laminates; and (2) a PC2 set, each of which had C2 laminates. And, two sets of sample sandwich composites were produced: (1) a PS3 set, each of which had S3 laminates; and (2) a PS4 set, each of which had S4 laminates. Average sandwich composite properties for each sandwich composite set are provided in TABLE 14.

TABLE 14
Sandwich Composite Properties*

| | Average | Average | Average |
|---|---|---|---|
| Sandwich | Thickness | Width | Areal Weight |
| Composites | (mm) | (mm) | (kg/m²) |
| PC1 | 24.60 | 69.79 | 3.56 |
| PC2 | 24.50 | 69.62 | 2.81 |
| PS3 | 24.72 | 69.53 | 3.63 |
| PS4 | 24.97 | 69.46 | 4.07 |

*All properties were measured.

### B. Structural Testing of Sample and Comparative Sandwich Composites

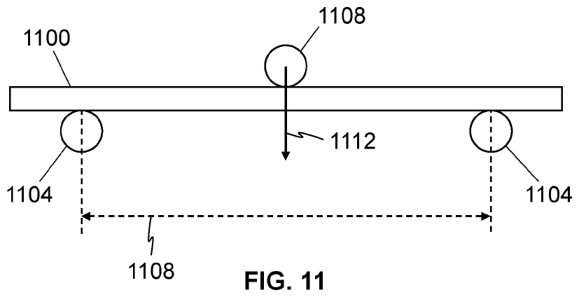

Six samples from each set of sandwich composites were subjected to a three-point bending test according to ASTM 7250. The samples, which were made pursuant to ASTM C393, each had the same width and a length of 200 mm; fibers of the outermost laminae of the sample extended along its length. FIG. 11 is a schematic view of the test setup. As shown, a sample 1100 to be tested was supported on two support bars 1104, with its length perpendicular to the support bars. The distance between the portion of each support bar 1104 in contact with sample 1100—support span length 1108—was 150 mm. A load bar 1108 was used to apply an increasing downward load 1112 to the portion of sample 1100 positioned halfway between the supported portions of the sample.

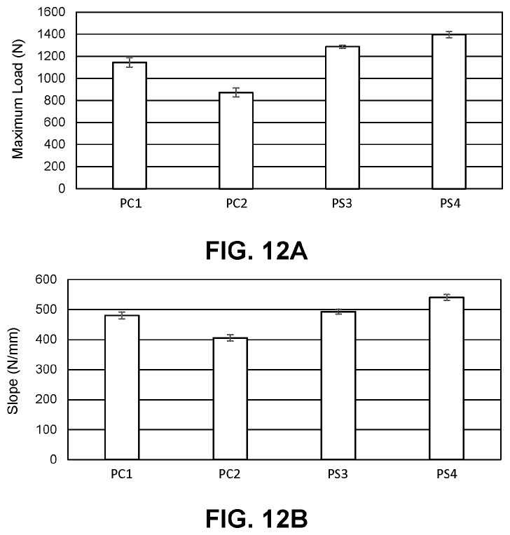

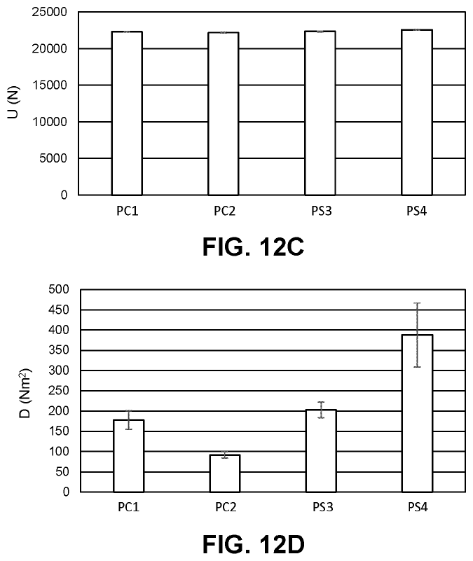

The results of three-point bending tests are shown in TABLE 15 and in FIGS. 12A-12D.

TABLE 15
Three-Point Bending Test Results for Sample
and Comparative Sandwich Composites

| | Maximum Load | | | | | | | |
|---|---|---|---|---|---|---|---|---|
| | (N) | | | | | | | |
| | | Standard | Slope | | | | D | |
| Sandwich | Average | Deviation | (N/mm) | | U(N) | | (Nm²) | |
| Composites | (Avg) | (σ) | Avg | σ | Avg | σ | Avg | σ |
| PC1 | 1144 | 42 | 481 | 12 | 22329 | 36 | 178 | 23 |
| PC2 | 872 | 41 | 406 | 11 | 22172 | 67 | 91 | 8 |
| PS3 | 1288 | 16 | 493 | 8 | 22353 | 54 | 203 | 19 |
| PS4 | 1398 | 29 | 541 | 10 | 22567 | 39 | 388 | 79 |

For a given sample, and thus sandwich composite from which the sample was produced, maximum load is the maximum load reached during testing of the sample, slope is that of the load vs. deflection curve for the sample between loads of 50 and 250 N (representative of the linear or Hookean region of that curve), U is the transverse shear stiffness of the sample, and D is the flexural stiffness of the sample.

Starting with maximum load (FIG. 12A), PS4 sandwich composites outperformed the other sandwich composites. This may be due to the laminates of the PS4 sandwich composites having relatively thick (0.250 mm) outermost laminae (as explained above, outermost laminae of a sandwich composite—and thus of its laminates—were positioned to best resist loads during the testing: with their fibers in the lengthwise direction). The PS4 sandwich composites also had the highest areal weights (TABLE 14). The PS3 sandwich composites, like the PS4 sandwich composites, outperformed both the PC1 and PC2 sandwich composites; thus, sandwich composites having symmetric laminates outperformed sandwich composites having asymmetric laminates.

Unexpectedly, the PS3 sandwich composites bore 12% more load than did the PC1 sandwich composites, despite being only 2% heavier (TABLE 14). And, the PS3 sandwich composites bore 47% more load than did the PC2 sandwich composites, but were only 29% heavier. Stated another way, the PS3 sandwich composites had a strength-to-weight ratio that was 10% higher than that of the PC1 sandwich composites and 14% higher than that of the PC2 sandwich composites.

The surprising nature of these results can be seen by comparing the laminate layups of the PC1 and PS3 sandwich composites. The PC1 sandwich composites' laminates each included a 0.250 mm thick 0° lamina and a 0.250 mm thick 90° lamina (TABLE 13). Similarly, the PS3 composites' laminates each included a 0.250 mm thick 0° lamina and two 900 laminae that, though having a collective thickness (0.312 mm) slightly larger than that (0.250 mm) of the single 90° lamina of each of the PC1 sandwich composites' laminates, had fiber weight fractions (61.71%) that were slightly lower than that (71.69%) of the single 90° lamina of each of the PC1 sandwich composites' laminates (TABLES 12 and 13). The PC1 and PS3 sandwich composites were therefore expected to perform similarly. Without wishing to be bound by theory, it appears that a laminate including roughly half-thickness 90° laminae positioned on opposing sides of 0° lamina(e) rather than full thickness 90° lamina(e) positioned on one side of the 0° lamina(e) (or swapping 90° for 0° and 0° for 90° in this sentence) not only captures the benefits of a symmetric layup (described above), but also has increased performance (higher maximum load and, as shown below, higher stiffnesses and ability to absorb energy), at least when used in a sandwich composite.

Turning to slope (FIG. 12B), the PS4 sandwich composites outperformed the other sandwich composites, which may be for the same reasons described above with respect to maximum load. Slope improvements for the PS3 sandwich composites over the PC1 sandwich composites (2%) and over the PC2 composites (21%), though smaller than the maximum load improvements, were present. Again, sandwich composites having symmetric laminates outperformed sandwich composites having asymmetric laminates.

With respect to transverse shear stiffness (FIG. 12C), the PC1, PC2, PS3, and PS4 sandwich composites performed similarly. The flexural stiffnesses of the sandwich composites (FIG. 12D), however, showed significant differences. As with maximum load and slope, and likely for the same reasons, the PS4 sandwich composites outperformed the other sandwich composites. Once again, the PS3 sandwich composites performed unexpectedly: despite being only 2% heavier than the PC1 sandwich composites, the PS3 sandwich composites had a flexural stiffness that was 14% higher than that of the PC1 sandwich composites, and the PS3 sandwich composites had a flexural stiffness that was 223% higher than that of the PC2 sandwich composites, but were only 29% heavier than the PC2 sandwich composites. Such performance may be a result of the structure of the PS3 composites described above with respect to maximum load. Like with maximum load and slope, sandwich composites having symmetric laminates outperformed sandwich composites having asymmetric laminates.

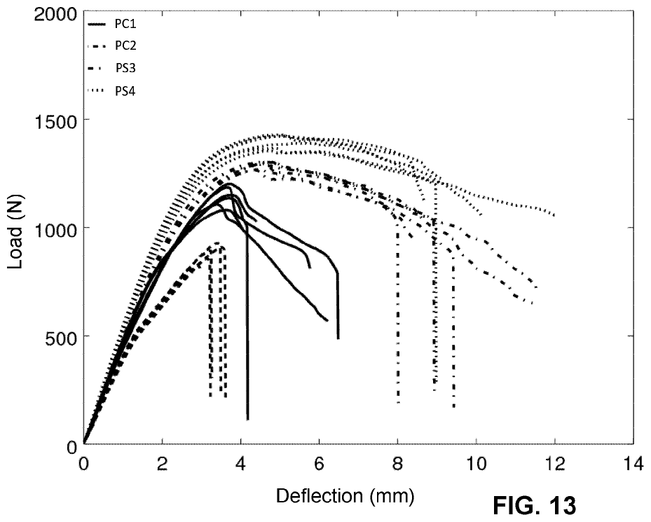

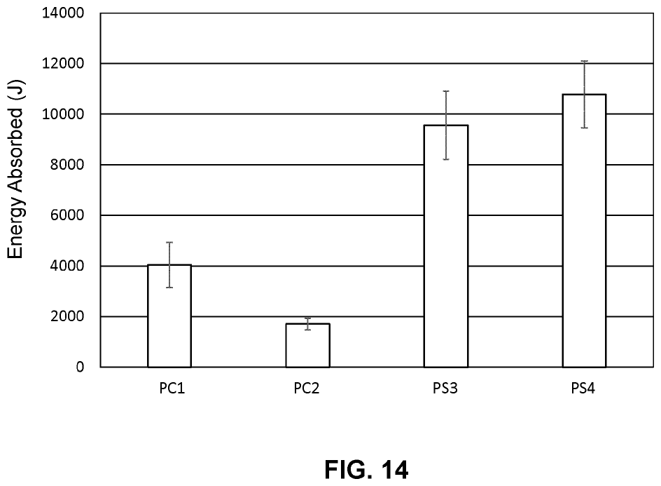

FIG. 13 depicts the load vs. deflection curve for each of the samples. By integrating these curves, the energy absorbed by each of the samples was determined; these energies, which are attributable to the respective sandwich composites from which the samples were produced, are provided in TABLE 16 and are charted in FIG. 14.

TABLE 16
Energy Absorbed by Sample and
Comparative Sandwich Composites

| | |
|---|---|
| Sandwich | Energy (J) |

| Composites | Avg | σ |
|---|---|---|
| PC1 | 4044 | 898 |
| PC2 | 1704 | 232 |
| PS3 | 9558 | 1343 |
| PS4 | 10781 | 1328 |

Not only did the PS3 and PS4 sandwich composites having symmetric laminates again outperform the PC1 and PC2 sandwich composites having asymmetric laminates, the PS3 sandwich composites continued to show unexpected results. Even though the PS3 sandwich composites were only 2% heavier than the PC1 sandwich composites, they absorbed 236% more energy than the PC1 sandwich composites. And, though only 29% heavier than the PC2 sandwich composites, the PS3 sandwich composites absorbed 560% more energy than the PC2 sandwich composites.

### C Structural Analysis of Sample and Comparative Sandwich Composites

Structural analysis of the PC1, PC2, PS3, and PS4 sandwich composites was performed to verify the above test results. Deflection of a given sandwich composite (δ) in response to a load (P) can be modelled as:

$$\frac{δ}{P} = \frac{2 {l}^{3}}{{B}_{1} {E}_{f} {btc}^{2}} + \frac{l}{{B}_{2} b {cG}_{c}^{*}} \qquad ( 1 )$$

where l and b are the length and width, respectively, of the sandwich composite, E_{f} and t are the modulus of elasticity and thickness, respectively, of each of the sandwich composite's laminates, and G_{c}* and c are the shear modulus and thickness, respectively, of the sandwich composite's core. LORNA J. GIBSON & MICHAEL F. ASHBY, CELLULAR SOLIDS (2nd ed. 1997). B₁ and B₂ are constants whose values depend on the loading scenario; for three-point bending, B₁ is equal to 48, and B₂ is equal to 4. Id. Slope for the sandwich composite can then be expressed as:

$$Slope = \frac{{P}_{1} - {P}_{2}}{δ ( {P}_{1} ) - δ ( {P}_{2} )} \qquad ( 2 )$$

The above equations were used to calculate the slope and areal weight of the PC1, PC2, PS3, and PS4 sandwich composites; these values, and comparisons to their measured counterparts (TABLES 14 and 15), are included in TABLE 17.

TABLE 17
Calculated vs. Measured Slope and Areal Weight
of Sample and Comparative Sandwich Composites

| | | Difference | Calculated | Difference |
|---|---|---|---|---|
| | Calculated | from Measured | Areal | from Measured |
| Sandwich | Slope | Slope | Weight | Areal Weight |
| Composites | (N/mm) | (%) | (kg/m²) | (%) |
| PC1 | 481 | 0% | 3.60 | 1% |
| PC2 | 416 | 3% | 2.83 | 1% |
| PS3 | 478 | −3% | 3.69 | 2% |
| PS4 | 520 | −4% | 4.07 | 0% |

As shown, there was good agreement between experiment and theory.

### D. Failure Modes of Sample and Comparative Sandwich Composites

The failure mode of each of the samples was characterized using the sandwich panel three part failure identification codes set forth in ASTM C393. These characterizations are included in TABLE 18.

TABLE 18
Sample and Comparative Sandwich Composite Failure Modes

| PC1 | | PC2 | | PS3 | | PS4 | |
|---|---|---|---|---|---|---|---|
| Sam- | | Sam- | | Sam- | | Sam- | |
| ple | Failure | ple | Failure | ple | Failure | ple | Failure |
| # | Code | # | Code | # | Code | # | Code |
| 1 | DAA | 1 | DAA | 1 | SGC | 1 | SGC |
| 2 | DAA | 2 | DAA | 2 | CAV | 2 | SGC |
| 3 | DAA | 3 | DAA | 3 | SGC | 3 | SGC |
| 4 | SGC | 4 | DAA | 4 | SGC | 4 | SGC |
| 5 | SGC | 5 | DAA | 5 | SGC | 5 | SGC |
| 6 | SGC | 6 | DAA | 6 | SGC | 6 | SGC |

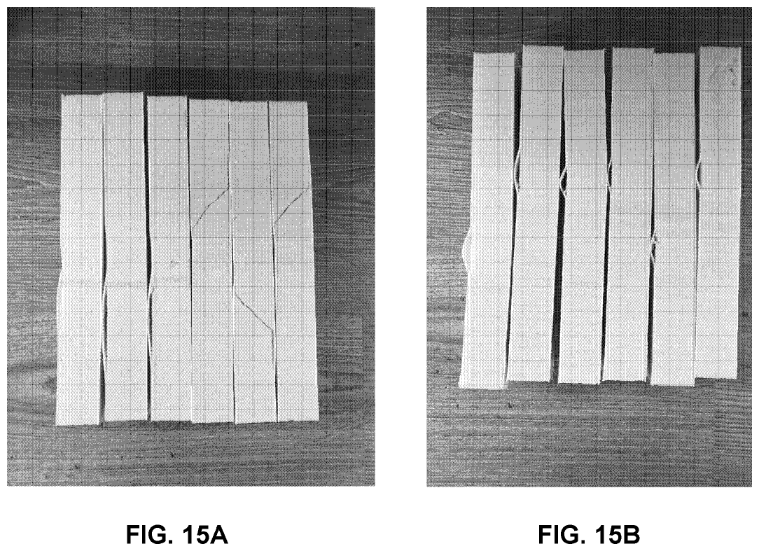

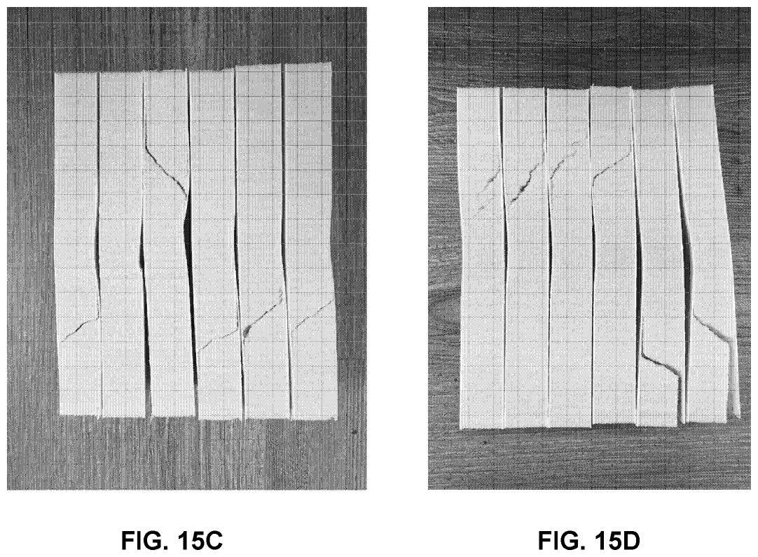

The samples, save for sample 2 of the PS3 sandwich composites, failed either: (1) proximate the load bar via delamination at a core-facing bond (DAA); or (2) via transverse shear of the core in the gage section of the sample (SGC). Sample 2 of the PS3 sandwich composites failed due to crushing of the core proximate the load bar (CAV). After-testing images of the samples showing these failures appear in FIGS. 15A-15D: FIG. 15A for the PC1 samples, FIG. 15B for the PC2 samples, FIG. 15C for the PS3 samples, and FIG. 15D for the PS4 samples.

Comparing the failure mode data to the maximum load, slope, and flexural stiffness data above, it was seen that stronger and stiffer sandwich composites failed via core shear, and weaker and more flexible sandwich composites failed via laminate-core delamination. To illustrate, the PS4 sandwich composites—the strongest and stiffest—each failed via core shear, and the PC2 composites—the weakest and most flexible—each failed via laminate-core delamination.

### E. Failure Mode Analysis of Sample and Comparative Sandwich Composites

To better understand why a given sandwich composite failed via core shear, and was thus a stronger and stiffer sandwich composite, or via laminate-core delamination, and was thus a weaker and more flexible sandwich composite, the mechanisms for these failures were investigated and compared.

The load at which a sandwich composite will fail via core shear (e.g., an SGC failure), P_{cs}, can be approximated by:

P_{cs}=B₄bcδ_{yc}* (3)

where δ_{yc}* is the core's shear strength: 0.5 MPa for the cores used in these examples. And, the load at which the sandwich composite will fail via laminate-core delamination (e.g., a DAA failure), P_{bf}, can be approximated by:

$${P}_{bf} = {B}_{3} bc \frac{t}{l} \sqrt{\frac{{G}_{c} {E}_{f}}{t}} \qquad ( 4 )$$

where G_{c} is the toughness of the adhesive between each of the laminates and the core (this was assumed to be the same for each of the sample and comparative composites). B₃ and B₄ are constants whose values depend on the loading scenario; for three-point bending, B₃ is equal to 2, and B₄ is equal to 4.

From Eqs. (3) and (4), it can be shown that there is a parameter, T, for predicting whether the sandwich composite will fail due to shear or due to delamination:

$$T = \frac{1}{{E}_{f} t} {( \frac{{B}_{4}}{{B}_{3}} {σ}_{yc} l )}^{2} \qquad ( 5 )$$

If T is greater than G_{c}, failure should be due to delamination, and if T is less than G_{c}, failure should be due to shear. T values for the PC1, PC2, PS3, and PS4 sandwich composites were calculated and are included in TABLE 19.

TABLE 19
T Values for Sample and Comparative Sandwich Composites

| Sandwich | T |
|---|---|
| Composites | (J/m²) |
| PC1 | 142 |
| PC2 | 293 |
| PS3 | 147 |
| PS4 | 75 |

As predicted, the sandwich composites with the lowest T values—the PS4 sandwich composites—failed due to core shear, and the sandwich composites with the highest T values—the PC2 sandwich composites—failed due to laminate-core delamination (TABLE 18). Unexpectedly, despite the PC1 and PS3 sandwich composites having similar T values, half of the PC1 composites failed due to delamination, while none of the PS3 composites failed due to delamination.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A sandwich composite comprising:
a core; and
first and second laminates disposed on opposing sides of the core, each of the laminates including:
three or more unidirectional (UD) laminae, each comprising:
a polymeric matrix material; and
fibers dispersed within the polymeric matrix material;
wherein the UD laminae are layered such that the laminate includes:
an inner section comprising one or more of the UD laminae:
in each of which, the fibers are aligned in a first direction; and
that collectively have a thickness; and
first and second outer sections disposed on opposing sides of the inner section, each of the outer sections including one or more of the UD laminae:
in each of which, the fibers are aligned in a second direction that is substantially perpendicular to the first direction; and
that collectively have a thickness;
wherein the thickness of the UD lamina(e) of the first outer section is substantially equal to the thickness of the UD lamina(e) of the second outer section; and
wherein the thickness of the UD lamina(e) of the inner section is 0.6 to 3.25 times the thickness of the UD lamina(e) of the first outer section and the thickness of the UD lamina(e) of the second outer section; and
wherein a collective thickness of the UD laminae is between approximately 0.4 millimeters (mm) and approximately 1.0 mm.

2. The sandwich composite of claim 1, wherein, for each of the laminates, the thickness of the UD lamina(e) of the inner section is 1.5 to 2.5 times the thickness of the UD lamina(e) of the first outer section and the thickness of the UD lamina(e) of the second outer section.

3. The sandwich composite of claim 2, wherein, for each of the laminates, the thickness of the UD lamina(e) of the inner section is 1.5 to 2.0 times the thickness of the UD lamina(e) of the first outer section and the thickness of the UD lamina(e) of the second outer section.

4. The sandwich composite of claim 3, wherein, for each of the laminates:
the thickness of the UD lamina(e) of the inner section is approximately 0.250 mm; and
the thickness of the UD lamina(e) of the first outer section and the thickness of the UD lamina(e) of the second outer section are each approximately 0.156 mm.

5. The sandwich composite of any of claims 1-3, wherein the thickness of the UD laminae of the first laminate is substantially equal to the thickness of the UD laminae of the second laminate.

6. The sandwich composite of any of claims 1-5, wherein, for each of the laminates:
the UD lamina(e) of the first outer section collectively have an areal weight that is substantially equal to a collective areal weight of the UD lamina(e) of the second outer section; and
the UD lamina(e) of the inner section collectively have an areal weight that is 0.5 to 3.7 times the areal weight of the UD lamina(e) of the first outer section and the areal weight of the UD lamina(e) of the second outer section.

7. A sandwich composite comprising:
a core: and
first and second laminates disposed on opposing sides of the core, each of the laminates including:
three or more UD laminae, each comprising:
a polymeric matrix material; and
fibers dispersed within the polymeric matrix material;
wherein the UD laminae are layered such that the laminate includes:
an inner section comprising one or more of the UD laminae:
in each of which, the fibers are aligned in a first direction; and
that collectively have an areal weight;
first and second outer sections disposed on opposing sides of the inner section, each of the outer sections including one or more of the UD laminae:
in each of which, the fibers are aligned in a second direction that is substantially perpendicular to the first direction; and
that collectively have an areal weight;
wherein the areal weight of the UD lamina(e) of the first outer section is substantially equal to the areal weight of the UD lamina(e) of the second outer section; and
wherein the areal weight of the UD lamina(e) of the inner section is 0.5 to 3.7 times the areal weight of the UD lamina(e) of the first outer section and the areal weight of the UD lamina(e) of the second outer section; and
wherein a collective areal weight of the UD laminae is between approximately 700 gsm and approximately 1700 grams per square meter (gsm).

8. The sandwich composite of claim 6 or 7, wherein, for each of the laminates, the areal weight of the UD lamina(e) of the inner section is 1.5 to 2.5 times the areal weight of the UD lamina(e) of the first outer section and the areal weight of the UD lamina(e) of the second outer section.

9. The sandwich composite of claim 8, as depending from claim 7, wherein, for each of the laminates, for each of the outer sections, the fiber weight fraction of the UD lamina(e) is less than or equal to 95%, optionally, less than or equal to 90%, of the fiber weight fraction of the UD lamina(e) of the inner section.

10. The sandwich composite of claim 8, wherein, for each of the laminates, the areal weight of the UD lamina(e) of the inner section is 1.5 to 2.0 times the areal weight of the UD lamina(e) of the first outer section and the areal weight of the UD lamina(e) of the second outer section.

11. The sandwich composite of claim 9, wherein, for each of the laminates:
the areal weight of the UD lamina(e) of the inner section is approximately 428 gsm; and
the areal weight of the UD lamina(e) of the first outer section and the areal weight of the UD lamina(e) of the second outer section are each approximately 237 gsm.

12. The sandwich composite of any of claims 1-11, wherein the fibers comprise carbon fibers, glass fibers, aramid fibers, polyethylene fibers, polyester fibers, polyamide fibers, ceramic fibers, basalt fibers, and/or steel fibers.

13. The sandwich composite of claim 12, wherein the fibers comprise carbon fibers and/or glass fibers.

14. The sandwich composite of any of claims 1-13, wherein the polymeric matrix material comprises a thermoplastic matrix material.

15. The sandwich composite of claim 14, wherein the thermoplastic matrix material comprises PP.

16. The sandwich composite of any of claims 1-15, wherein the core comprises foam and/or a honeycomb structure.

17. The sandwich composite of any of claims 1-16, wherein a thickness of the core is between 20 and 60 times the thickness of the UD laminae of the first laminate and the thickness of the UD laminae of the second laminate.

18. The sandwich composite of any of claims 1-17, comprising, for each of the laminates, an adhesive disposed between the laminate and the core.
